(19) United States
(12) Patent Application Publication
(10) Pub. No.: US 2004/0261033 A1
(43) Pub. Date: Dec. 23, 2004

(54) Communication system that provides users with the capability to record video messages that are broadcast live over the Internet and simultaneously translated into various languages

(76) Inventor: Ray Mabon, Gardena, CA (US)

Correspondence Address: Ray Mabon, 1364 West 139th Street, Unit A, Gardena, CA, 90249, US

(21) Appl. No.: 10/601,426

(22) Filed: Jun. 23, 2003

(51) Int. Cl. G06F 17/00

(52) U.S. Cl. 715/751

(57) ABSTRACT

The Communication System is comprised of a website that allows users to make video expressions of their opinion on a variety of issues that are broadcast in real time and translated into various languages. The Communication System also features audio/video cellular phones and telecommunication kiosks that can be used to produce video expressions. send/receive video emails, and conduct video conferences by those who do not have a computer, do not have Internet access, or are temporarily away from their computer.

### BACKGROUND OF THE INVENTION

It has been said that everyone will have their 15 minutes of fame and man in general is a creature that likes to share their opinions on a wide variety of subjects as well as talk about themselves. In addition, with America on the brink of war with Iraq, it appears that everyone in the world has an opinion as to what should or should not be the next step taken. The point is that everyone has something to say about virtually any subject under the sun. The current vehicles of expression such as Talk Radio, newspapers, and television news broadcasts are limited in the amount of people whose views or opinions can be expressed due to time limitations on programs and the like. The invention outlined here will overcome those obstacles by utilizing the Internet to allow people to express their opinions about a wide variety of subjects. This communication system will involve people being able to make a video recording of themselves expressing their opinion on a given subject and having that recording transmitted live as well as re-broadcast over the Internet. This invention would allow for the person expressing their views to be seen vs being unseen as in a talk radio or Internet chat room situation. In addition, the communication system would incorporate a universal translator to translate the message into various languages. As a result, this communication system would bring together cultures and peoples that at this point have been isolated and separated from each other, which has resulted in the current global climate we have of fear, distrust, and suspicion.

### BRIEF SUMMARY OF THE INVENTION

The Communication System is one that provides the user with the capability to record video messages of themselves expressing their opinion on a wide variety of subjects which are then broadcast live or re-broadcast over the Internet. This system will incorporate an interactive website equipped with a universal translator to translate the video message into various languages as well as custom kiosks located in public areas that could be utilized to record video messages by those who do not have Internet access or are temporarily away from their computers. The communication system would involve a website that users could go to record their video messages on as well as to view live debates and discussions between the great minds of our time. In addition, the communication system would incorporate an audio/video cellular phone that could be used to tap into the website by those who do not have access to the Internet.

### DESCRIPTION OF DRAWINGS

FIG. 1 is a block diagram of the Communication System

FIG. 2 is a flowchart of the Communication System

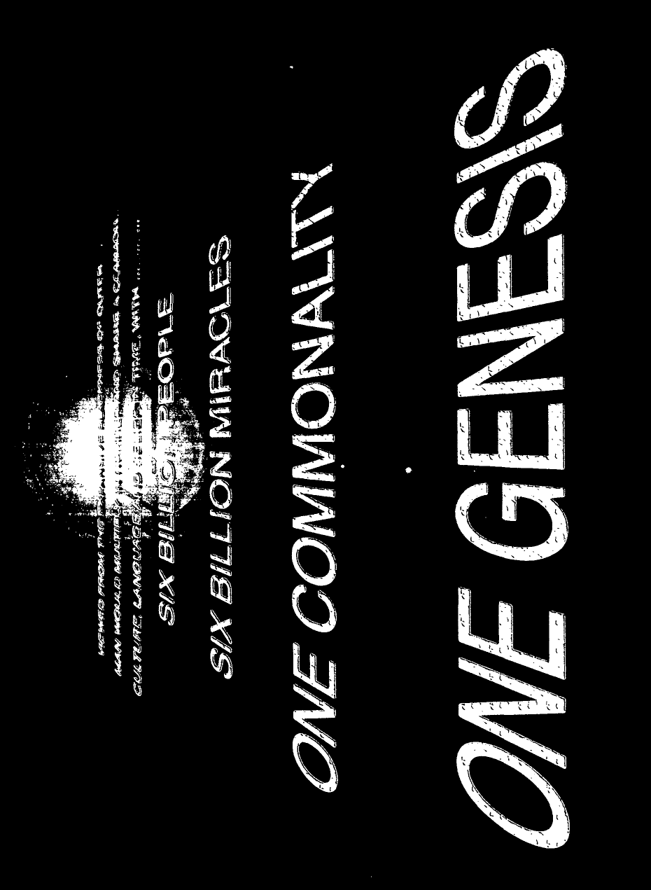

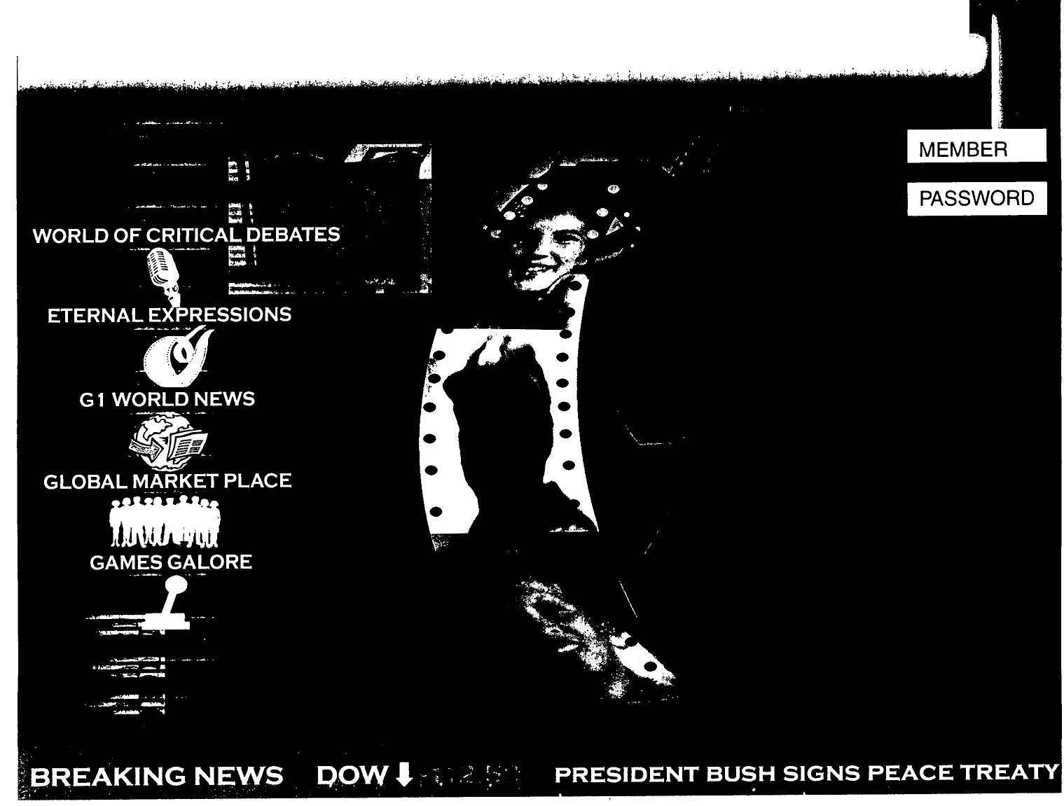

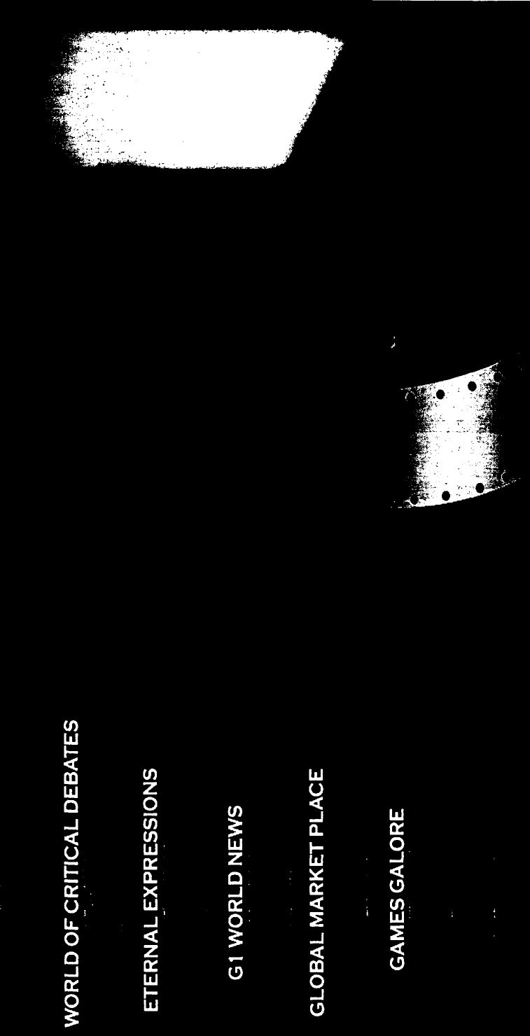

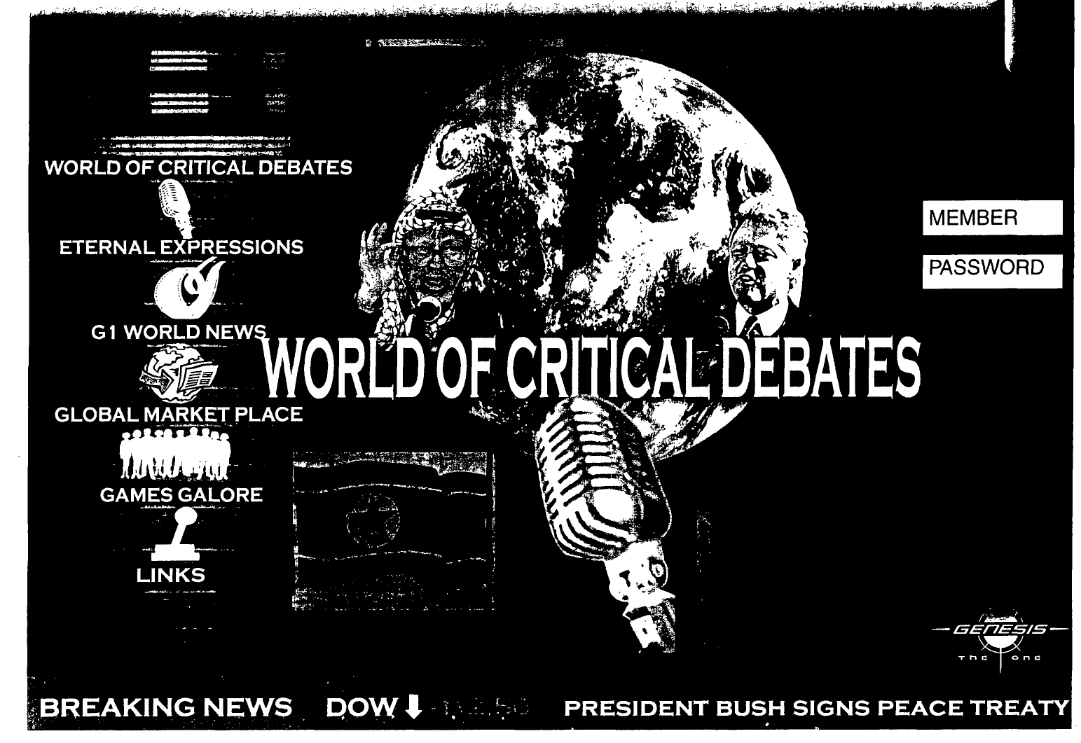

### DETAILED DESCRIPTION OF THE INVENTION

The Communication System is one that provides the user with the capability to record video messages of themselves expressing their opinion on a wide variety of subjects which are then broadcast live or re-broadcast over the Internet. This system will incorporate an interactive website equipped with a universal translator to translate the video message into various languages as well as custom kiosks located in public areas that could be utilized to record video messages by those who do not have Internet access or are temporarily away from their computers. In addition to recording live video messages, users could view live debates and discussions between the great minds of our time on a wide variety of subjects. The communication system would also incorporate a video cellular phone that could be utilized to access the website by those who do not have access to the Internet or are temporarily away from their computer. The following is a more detailed description of each element of the communication system:

I. Interactive Website

The interactive website is comprised of the following elements:

A. The opening screen of the website features a Birth and Death counter that gives the viewer visual reminders of the sheer amount of people being born and the sheer volume of deaths in the world.

B. A Scroll of Life is featured on the website which unfurls with written words of life as well as words that produce a respect for life. The speed at which the scroll unfurls is related to the speed at which the Birth and Death counter changes.

C. A Wheel of Life which is the portal of the website. This Wheel of Life, which has pictures of people on it, can be clicked on by user to reveal a list of current and archived video message expressions on a variety of issues.

D. A Time Capsule that the user can place items such as but not limited to living wills, creative ideas, words of wisdom for children or grandchildren, and testimonies of their presence on earth during a particular period of time.

E. A Live Expression link that would involve live broadcasts and rebroadcasts of video messages of individuals expressing their opinions on a wide variety of subjects.

F. Portal to The World Of Critical Debates featuring the world's greatest scholars discussing global issues. Viewers have the capability to listen and interact with the world's greatest thinkers in real time with the discussions translated into various languages. The portal would be fully interactive with a global audience and would stimulate the solving of the world's problems by a collective voice of masses. This type of interaction could be the beginnings of global peace.

G. The Exchange, the chat room of chat rooms, where users from around the world would have the ability to share their opinions on a wide variety of subjects, business information, or whatever they desire with anyone in the world with the added benefit of being able to actually see and hear chat room participants in real time and with translation into various languages.

H. A Mall and Auction Site where items from around the world will be bought and sold. This site has the potential to dwarf current auction websites due to the sheer volume of the global membership base listing items on the website.

II. Audio/Video Cellular Phone with screens comprised of but not limited to liquid crystal display, plasma, and the like which allow the user to log onto the website for the communication system as well as make video expressions of their opinions on a wide variety of issues which in turn are broadcast in real time or rebroadcast at a future time. The real time broadcast and rebroadcasts are done with translation into various languages.

III. Telecommunications Kiosk with the capability of allowing users who do not have access to a computer or the Internet to make video expressions of their opinions on a wide variety of subjects which are then broadcast in real time or rebroadcast over the Communication System's website with translation into various languages. The Telecommunications Kiosk will also allow the user to send and/or receive video e-mails as well as allow the user to link up with others they desire to have a video conference with.

I claim the following:

1. Communication System capable of enabling users to make a video recording of an expression or opinion on a wide variety of subjects which is then broadcast in real time or rebroadcast over the Internet.

2. Communication System utilizing a universal translator capable of translating video recordings, expressions, and other communications into various languages while they are broadcast over the Internet.

3. Communication System comprised of a website that utilizes a birth and death counter that informs the user of the rates of births and deaths occurring worldwide and in real time.

4. A Communication System that allows the user to place a video expression in a time capsule for viewing by the public, family members, or other entities at a designated point in time.

5. A Communication System with the capability to broadcast in real time and rebroadcast the world's greatest scholars discussing and debating global issues.

6. A Communication System with the capability of allowing the Internet audience to listen and interact with the world's greatest scholars during real time discussions and debates concerning global issues.

7. A Communication System with the capability of translating real time and rebroadcast discussions and debates conducted by the world's greatest scholars into various languages.

8. A Communication System featuring a chat room with the added feature of participants being able to actually see the person they are interacting with in real time and with translation into various languages.

9. A Communication System featuring a multilingual mall and auction site comprised of items from around the world.

10. A Communication System featuring an audio/video cellular phone allowing members to log onto the website if they do not own a computer and/or are temporarily away from a computer.

11. A Communication System featuring telecommunication kiosks that allow users to broadcast a video expressions including but not limited to living wills, words of wisdom for future generations, creative ideas, and their testimony of their existence on earth.

12. A Communication System featuring telecommunication kiosks equipped with a universal translator that translates video expression into various languages in real time.

13. A Communication System offering a top of tle line 24-hour, 7-day a week news and current events service. (The current events will be regionalized by country for example “for Britain the issues effecting the lives of the average citizen. In the Middle East, the question of regional conflict vs the desire for peace; In America, issues such as but not limited to the question of abortion, the state of the political arena; etc.)

14. A Communication System that allows the user to view archived as well as contemporary movies, which can be accessed either through a computer or the audio/video cellular phone that is part of the Communication System.

15. A Communication System that allows the user to access a vast music database that can be enjoyed with the use of a computer or the audio/video cellular phone that is part of the Communication System.

16. A Communication System that allows the user to access a vast database of games that can be played on a computer or on the audio/video cellular phone that is part of the Communication System.
